(19) United States
(12) Patent Application Publication
(10) Pub. No.: US 2015/0334365 A1
(43) Pub. Date: Nov. 19, 2015

(54) STEREOSCOPIC IMAGE PROCESSING APPARATUS, STEREOSCOPIC IMAGE PROCESSING METHOD, AND RECORDING MEDIUM

(71) Applicants: Sharp Kabushiki Kaisha, Osaka-shi, Osaka (JP); Kochi University of Technology, Kami-shi, Kochi (JP)

(72) Inventors: Ikuko Tsubaki, Osaka-shi (JP); Hiroaki Shigemasu, Kami-shi (JP)

(21) Appl. No.: 14/647,456

(22) PCT Filed: Oct. 11, 2013
(86) PCT No.: PCT/JP2013/077716

§ 371 Date: May 27, 2015

(30) Foreign Application Priority Data
Nov. 29, 2012 (JP) 2012-260658

(51) Int. Cl. H04N 13/00; G06T 15/20

(52) U.S. Cl. CPC H04N 13/0022; H04N 13/0033; G06T 15/20; G06T 2215/06

(57) ABSTRACT

The present invention makes it possible to adaptively convert distribution of disparities or depths of a stereoscopic image according to a visual property of a human related to stereopsis. A stereoscopic image processing apparatus according to the present invention is a stereoscopic image processing apparatus which receives an input stereoscopic image, and converts distribution of disparities or depths of the input stereoscopic image, the apparatus includes a planar region extracting unit (31) which extracts a planar region in the stereoscopic image; a non-planar region conversion processing unit (exemplified using non-planar region disparity conversion processing unit (32)) which performs a first conversion process in which the disparity or the depth is converted with respect to a non-planar region which is a region other than the planar region; and a planar region conversion processing unit (exemplified using planar region disparity conversion processing unit (33)) which performs a second conversion process in which the disparity or the depth is converted using a conversion property which is different from that in the first conversion process with respect to the planar region. Here, the first conversion process is a process in which a conversion based on a non-linear conversion property is performed related to the disparity or the depth with respect to the non-planar region.

### TECHNICAL FIELD

The present invention relates to a stereoscopic image processing apparatus, a stereoscopic image processing method, and a program which perform processing of a stereoscopic image.

### BACKGROUND ART

In recent years, in a technology which is used for displaying a stereoscopic image using an image display device, a stereoscopic display is executed by presenting different images in left and right eyes of a human, and the human perceives a three-dimensional sensation due to disparity which is a shift of objects in the images for left and right eyes. In the stereoscopic display, there is a problem in that it is difficult to execute stereopsis if disparity becomes large, and exceeds a tolerance limit of a visual property of a human, and causes fatigue and unpleasantness of a user.

In PTL 1, a method is disclosed in which distribution of disparity in an input image falls in a predetermined range by performing a shift process in which a relative position of images for left and right eyes is shifted in a horizontal direction, and a scaling process in which magnification and reduction is performed by taking a center of the images for left and right eyes after being subjected to such an image conversion as a reference. In PTL 2, a map conversion method in which a depth map is converted using existence frequency of a depth in an image region so as to obtain a good sense of depth in a depth range which can be reproduced is disclosed.

FIG. 6A is a diagram which illustrates an example of a linear disparity or depth conversion property in the related art, and FIG. 6B is a diagram which illustrates an example of a non-linear disparity or depth conversion property in the related art. In the method which is described in PTL 1, a conversion process using a linear conversion property is performed with respect to disparity as illustrated in FIG. 6A, and in the method which is described in PTL 2, a conversion process using a non-linear conversion property is performed with respect to a depth as illustrated in FIG. 6B. In any of FIG. 6A and FIG. 6B, d denotes input values of disparities or depths, and D denotes output values (conversion values) with respect to d, which are output values of disparities or depths. That is, both the linear conversion property which is illustrated in FIG. 6A and the non-linear conversion property which is illustrated in FIG. 6B can be applied to both a case in which disparity value is output by converting the disparity value and a case in which a depth value is output by converting the depth value. In addition, in FIGS. 6A and 6B, dmin denotes a minimum value of an input value, dmax denotes a maximum value of the input value, Dmin denotes a minimum value of an output value, and Dmax denotes a maximum value of the output value, respectively.

### CITATION LIST

### Patent Literature

PTL 1: Japanese Unexamined Patent Application Publication No. 2011-55022

PTL 2: Japanese Unexamined Patent Application Publication No. 2012-134881

### Non Patent Literature

NPL 1: The Mechanism of “Cardboard Cut-out Phenomenon” by Hiroaki Shigemasu and Takao Sato, Transactions of the Virtual Reality Society of Japan, 10(2), pp. 249-256, 2005.

### SUMMARY OF INVENTION

### Technical Problem

Meanwhile, it is known that, if there is a discontinuous change in depth between objects, perception of a continuous change in depth in an object is suppressed in stereopsis, and an unnatural three-dimensional sensation easily occurs (refer to NPL 1).

However, in disparity adjusting technologies in the related art including the technology which is described in PTL 1, such a visual property and unnatural three-dimensional sensation are not taken into consideration. In addition, with the use of the method which is described in PTL 2, it is considered that there is an effect of reducing the discontinuous depth change between objects. However, since a connection of a depth with a vicinity pixel is not taken into consideration in the method which is described in PTL 2, for example, there is a case in which gradient changes in the middle of a plane due to a conversion, and it becomes a depth in a curved surface shape in an inclined plane, that is, in a plane in which the depth changes at constant gradient, and an unnaturalness newly occurs.

The present invention has been made in consideration of the above described facts, and an object thereof is to provide a stereoscopic image processing apparatus, a stereoscopic image processing method, and a program for processing a stereoscopic image, which can adaptively converts distribution of disparities or depths of a stereoscopic image according to a visual property of a human related to stereopsis.

### Solution to Problem

In order to solve the above described problem, according to a first technical means of the present invention, there is provided a stereoscopic image processing apparatus which receives an input stereoscopic image, and converts distribution of disparities or depths of the input stereoscopic image, the apparatus including a planar region extracting unit which extracts a planar region in the stereoscopic image; a non-planar region conversion processing unit which performs a first conversion process in which the disparity or the depth is converted with respect to a non-planar region which is a region other than the planar region; and a planar region conversion processing unit which performs a second conversion process in which the disparity or the depth is converted using a conversion property which is different from that in the first conversion process with respect to the planar region, in which the first conversion process is a process in which a conversion based on a non-linear conversion property is performed related to the disparity or the depth with respect to the non-planar region.

According to a second technical means of the present invention, in the first technical means, the first conversion process may be a process in which a conversion based on a histogram equalization process of the disparity or the depth is performed with respect to the non-planar region.

According to a third technical means of the present invention, in the first or second technical means, the second conversion process may be a process in which a conversion based on a linear conversion property is performed related to the disparity or the depth with respect to the planar region.

According to a fourth technical means of the present invention, there is provided a stereoscopic image processing method in which a stereoscopic image is input, and distribution of disparities or depths of the input stereoscopic image is converted, the method including a step of extracting a planar region in the stereoscopic image using a planar region extracting unit; a step of performing a first conversion process in which the disparity or the depth is converted with respect to a non-planar region which is a region other than the planar region using a non-planar region conversion processing unit; and a step of performing a second conversion process in which the disparity or the depth is converted using a conversion property which is different from that in the first conversion process with respect to the planar region using a planar region conversion processing unit, in which the first conversion process is a process in which a conversion based on a non-linear conversion property is performed related to the disparity or the depth with respect to the non-planar region.

According to a fifth technical means of the present invention, there is provided a program which causes a computer to execute stereoscopic image processing in which a stereoscopic image is input, and distribution of disparities or depths of the input stereoscopic image is converted, the stereoscopic image processing including a step of extracting a planar region in the stereoscopic image; a step of performing a first conversion process in which the disparity or the depth is converted with respect to a non-planar region which is a region other than the planar region; and a step of performing a second conversion process in which the disparity or the depth is converted using a conversion property which is different from that in the first conversion process with respect to the planar region, in which the first conversion process is a process in which a conversion based on a non-linear conversion property is performed related to the disparity or the depth with respect to the non-planar region.

### Advantageous Effects of Invention

According to the present invention, it is possible to adaptively convert distribution of disparities or depths of a stereoscopic image according to a visual property of a human related to stereopsis, and to avoid an unnatural three-dimensional sensation in which a continuous depth change is deficient without an occurrence of unnaturalness in a planar region of an object, and accordingly, it is possible to present a good three-dimensional sensation to a viewer.

### BRIEF DESCRIPTION OF DRAWINGS

FIG. 1 is a block diagram which illustrates a configuration example of a stereoscopic image display apparatus which includes a stereoscopic image processing apparatus according to one embodiment of the present invention.

FIG. 2A is a diagram which describes an example of a conversion process in a non-planar region disparity conversion processing unit in the stereoscopic image display apparatus in FIG. 1, and which illustrates an example of an input disparity histogram.

FIG. 2B is a diagram which describes an example of a conversion process in the non-planar region disparity conversion processing unit in the stereoscopic image display apparatus in FIG. 1, and which illustrates an example of a disparity histogram after a conversion which is a histogram obtained by performing a conversion process with respect to the input disparity histogram in FIG. 2A.

FIG. 3A is a diagram which illustrates an example of a disparity map which is input to a disparity distribution conversion unit in the stereoscopic image display apparatus in FIG. 1.

FIG. 3B is a diagram which illustrates an example of a result which is obtained by performing a labeling process in a planar region extracting unit with respect to FIG. 3A.

FIG. 4A is a diagram in which a disparity value of a row corresponding to a dotted line in the disparity map in FIG. 3A is made into a graph by assigning a vertical axis to disparity values, and a horizontal axis to coordinates in a horizontal direction.

FIG. 4B is a diagram which illustrates an example of a disparity map in each row after being processed in the disparity distribution conversion unit with respect to FIG. 4A.

FIG. 4C is a diagram which illustrates an example of a disparity map in each row after being subject to a disparity distribution conversion in the related art with respect to FIG. 4A.

FIG. 5 is a flowchart which describes a processing example of an image generation unit in the stereoscopic image display apparatus in FIG. 1.

FIG. 6A is a diagram which illustrates an example of a linear disparity or depth conversion property in the related art.

FIG. 6B is a diagram which illustrates an example of a non-linear disparity or depth conversion property in the related art.

### DESCRIPTION OF EMBODIMENTS

A stereoscopic image processing apparatus according to the present invention is an apparatus which receives an input stereoscopic image, and converts distribution of disparities or depths of an input stereoscopic image, and converts distribution of disparities or depths using a conversion property which is different between a planar region and a region other than the planar portion in an object with respect to a stereoscopic image. That is, the stereoscopic image processing apparatus according to the present invention is an apparatus which includes a conversion processing unit which performs such a conversion, and in which adjusting of disparities or depths can be executed so as to adaptively convert an input stereoscopic image according to a visual property of a human related to stereopsis.

In addition, it is preferable that the conversion processing unit converts distribution of disparities or depths in a planar region in an object linearly, and converts distribution of disparities or depths non-linearly so as to reduce a discontinuous change in a region other than that. The stereoscopic image processing apparatus according to the embodiment is an apparatus which can execute adjusting of disparities or depths so that an unnaturalness does not occur in a planar region of an object, or so that a difference in a disparity value or a depth value at a boundary of an object (region in which disparity value or a depth value is changed discontinuously) is reduced (so as to avoid unnatural three-dimensional sensation in which a continuous depth change is deficient without suppressing perception of the continuous depth change in object) with respect to an input stereoscopic image. That is, in the stereoscopic image processing apparatus according to the embodiment, it is possible to present a good three-dimensional sensation to a viewer since an unnatural three-dimensional sensation is avoided in a planar region of an object, and suppressing of perception of a continuous depth change in an object is avoided with respect to an input stereoscopic image.

Hereinafter, one embodiment of the present invention will be described in detail with reference to accompanying drawings. Here, an example in which disparity distribution is converted, that is, disparity adjusting is performed, will be described.

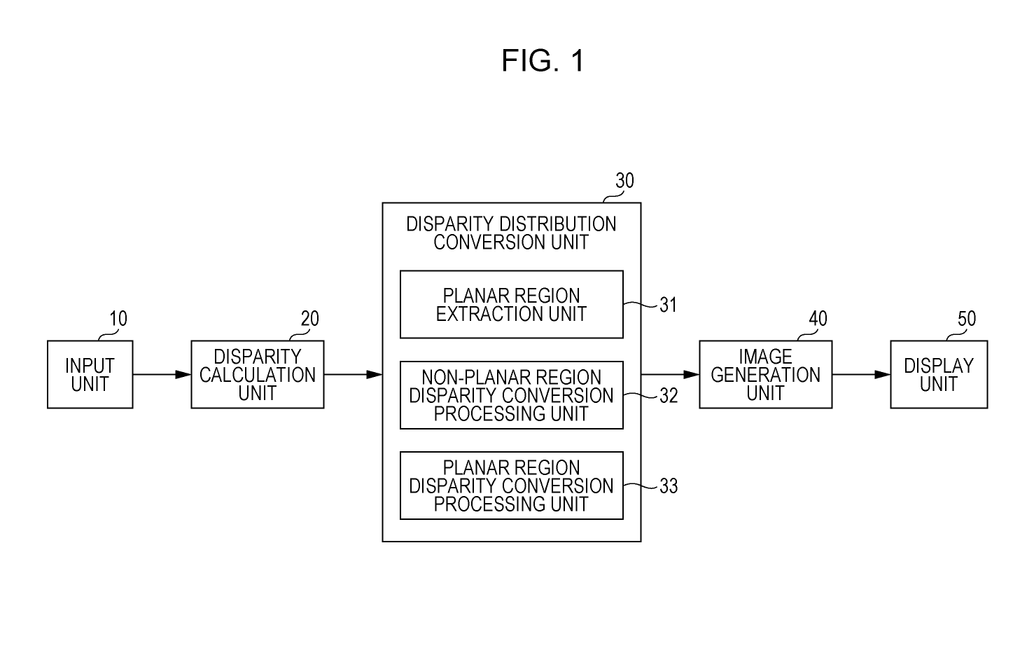

FIG. 1 is a block diagram which illustrates a configuration example of a stereoscopic image display apparatus which includes a stereoscopic image processing apparatus according to the embodiment of the present invention.

As illustrated in FIG. 1, the stereoscopic image display apparatus according to the embodiment includes an input unit 10 which inputs a stereoscopic image which is formed of a plurality of viewpoint images, a disparity calculation unit 20 which calculates a disparity map from a reference viewpoint image and a separate viewpoint image by taking one of the plurality of viewpoint images as the reference viewpoint image, and remaining viewpoint images as the separate viewpoint image, a disparity distribution conversion unit 30 which changes (converts) a disparity distribution of a stereoscopic image by changing the disparity map which is obtained in the disparity calculation unit 20, an image generation unit 40 which reconstitutes a separate viewpoint image from the reference viewpoint image, and a disparity distribution after conversion in the disparity distribution conversion unit 30, and a display unit 50 which performs a two-eye or multi-eye stereoscopic display using the reference viewpoint image, and the separate viewpoint image which is generated in the image generation unit 40.

The disparity distribution conversion unit 30 is an example of the conversion processing unit which is main characteristics of the present invention. Accordingly, as the main characteristics of the embodiment in the present invention, disparity distribution of a stereoscopic image may be converted as described below, by including at least the disparity distribution conversion unit 30 among the input unit 10, the disparity calculation unit 20, the disparity distribution conversion unit 30, the image generation unit 40, and the display unit 50. However, the disparity distribution conversion unit 30 according to the embodiment may not execute conversion of disparity distribution by converting a disparity map, or may execute the conversion using another method.

Hereinafter, each unit in the stereoscopic image display apparatus according to the embodiment will be described in detail.

The input unit 10 inputs data of a stereoscopic image (stereoscopic image data), and outputs a reference viewpoint image and a separate viewpoint image from the input stereoscopic image data. Here, the input stereoscopic image data may be any one of data which is obtained by being photographed using a camera, data using a broadcasting wave, data which is electronically read from a local storage device or a portable recording media, data which is obtained from an external server, or the like, using a communication, or the like.

In addition, the stereoscopic image data is configured of right eye image data and left eye image data in a case where a two-eye stereoscopic display is performed in the display unit 50, and is multi-viewpoint image data for a multi-eye display which is configured of viewpoint images of three or more in a case where the display unit 50 performs the multi-eye stereoscopic display. In a case where the stereoscopic image data is configured of the right eye image data and the left eye image data, one is used as the reference viewpoint image, and the other is used as the separate viewpoint image, and in a case where the stereoscopic image data is the multi-viewpoint image data, one of the plurality of viewpoint images is taken as the reference viewpoint image, and the remaining viewpoint image as the separate viewpoint image.

In addition, in the description in FIG. 1, or in the following description, it is assumed that stereoscopic image data is formed of data of a plurality of viewpoint images, basically; however, the stereoscopic image data may be configured of image data and depth data, or image data and disparity data. In this case, depth data or disparity data is output from the input unit 10 as a separate viewpoint image; however, the image data may be used as the reference viewpoint image, and the depth data or the disparity data may be used as a disparity map.

In the case of such a configuration, the disparity calculation unit 20 may be omitted in the stereoscopic image display apparatus in FIG. 1, and disparity distribution of a stereoscopic image may be changed (converted) when the disparity distribution conversion unit 30 changes the disparity map which is input in the input unit 10. However, in a case where it is not a format of the disparity map which can be processed in the image generation unit 40, the disparity calculation unit 20 may perform conversion into such a format by providing the disparity calculation unit 20. Hereinafter, a case in which depth data or disparity data is used will be additionally and simply described.

In the disparity calculation unit 20, a disparity map between the reference viewpoint image and the residual viewpoint image, that is, a disparity map of respective separate viewpoint images with respect to the reference viewpoint image is calculated in the example. The disparity map is a map in which a difference value of coordinates in a transverse direction (horizontal direction) between corresponding points in the reference viewpoint image is written, in each pixel of the separate viewpoint image, that is, a map in which a difference value of corresponding coordinates in the transverse direction in each pixel between stereoscopic images is written. The disparity value is set to a value which becomes larger as going toward a popup direction, and is set to a value which becomes smaller as going toward a depth direction.

As a disparity map calculation method, various methods using block matching, dynamic programming, graph cut, and the like, are known, and any one of them may be used. In addition, only disparity in the transverse direction has been described; however, in a case where disparity in the longitudinal direction is also present, similarly, it is also possible to perform a calculation of a disparity map, or a conversion of disparity distribution in the longitudinal direction.

The disparity distribution conversion unit 30 includes a planar region extraction unit 31, a non-planar region disparity conversion processing unit 32, and a planar region disparity conversion processing unit 33.

In the planar region extraction unit 31, a planar region in a stereoscopic image is extracted. As a matter of course, as a process, extraction of the planar region may be performed by extracting a non-planar region. In the example, the planar region extraction unit 31 extracts a planar region using a disparity map d(x, y) which is obtained in the disparity calculation unit 20. First, a horizontal gradient map Gx(x, y), and a vertical gradient map Gy(x, y) are created using the following expressions (1) and (2).

Gx(x, y)=d(x+1, y)−d(x−1, y) (1)

Gy(x, y)=d(x, y+1)−d(x, y−1) (2)

In a case of denoting coordinates other than an image at an image end of the disparity map in expressions (1) and (2), replacing is performed using coordinates in an image which is closest. Subsequently, in a labeling process, a region in which respective values of the horizontal gradient map and the vertical gradient map take constant values and in which pixels are connected is extracted.

There are various methods in the labeling process; however, as an example, first, (I) a pixel at the upper left end is determined to be a target pixel, the target pixel is moved using raster scan, and the following process is performed with respect to all of pixels. In addition, a case gradient is the same described below is a case in which a absolute difference value of the horizontal gradient map Gx(x, y), and a absolute difference value of the vertical gradient map Gy(x, y) of two pixels are smaller than a predetermined threshold value, respectively.

(II) In a case where gradient of the target pixel, and gradient of a neighboring pixel on the upper side are the same, a label of the pixel neighboring on the upper side is assigned to the target pixel. At this time, in a case where gradient of the target pixel, and gradient of the neighboring pixel on the left side are the same, and the label is different from a label of the neighboring pixel on the upper side, it is recorded in a lookup table that the two labels are the same regions.

Meanwhile, (III) in a case where gradient of the target pixel, and gradient of the neighboring pixel on the upper side are not the same, whether or not gradient of the target pixel and gradient of the neighboring pixel on the left side are the same is confirmed, and in a case where the gradients are the same, a label of a neighboring pixel on the left side is assigned to the target pixel. In addition, (IV) in a case where gradients of both of neighboring pixels on the upper side and on the left side of the target pixel are different from that of the target pixel, a new label of sequential order which is arbitrary or predetermined is assigned to the target pixel.

The processes in the above described (II) to (IV) are repeated until there is no pixel to be scanned. In the above described (II) to (IV), there is no neighboring pixel on the upper side or on the left side, respectively, in a pixel in the upper end row, or in the left end column; however, in such a case, it may be considered that gradient of the neighboring pixel on the upper side, or gradient of the neighboring pixel on the left side is not the same. In addition, in the above descriptions, when assigning a new label, a label value 1 is assigned first time, and a label value which becomes larger by 1 in order is assigned in the second time and thereafter. However, the new label value may have any numerical value.

Subsequently, (V) scanning is performed again from a pixel on the upper left end, a label with a minimum label value is selected from among labels which belong to the same region with reference to the lookup table, and a label is reattached so as to match the label. Finally, (VI) in a case where the number of pixels in a region which belongs to the same label is a threshold value or less, it is determined that the region is not planar, and label values of all of pixels which belong to the label are set to “0”. Meanwhile, (VII) in a case where the number of pixels which belong to the same label is larger than the threshold value, the label value is not changed.

In this manner, in the exemplified labeling process, in a case where the number of pixels is a threshold value or less (that is, narrow region) in (VI), it is determined to be a non-planar region, and a region other than that (that is, wide region) in (VII) is determined to be a planar region. As an additional remark, since all of pixels in the same plane have the same value in gradient, a plane with an area larger than the threshold value which is used in (VII) is extracted as a planar region. In addition, even in a case where it is not a plane, in a curved face with a small curvature, a neighboring pixel with similar gradient becomes a region with the same label according to a threshold value which is used when determining that gradients are the same, and is extracted as a planar region. A degree of being extracted as a planar region can be adjusted using the threshold value which is used in (VII), and a threshold value which is used when determining that gradients are the same.

In this manner, the region of which a provided label value is 0 is determined to be a non-planar region, and the region of which a label value is larger than 1 is determined to be a planar region, respectively. In the above described example, a case in which a determination on connection is performed using four connections; however, it may be eight connections. In addition, another labeling method such as a method of using contour tracking may be used.

The non-planar region disparity conversion processing unit 32 performs a first conversion process in which disparity is converted with respect to a non-planar region which is a region other than a planar region. In the example, the non-planar region disparity conversion processing unit 32 converts an input disparity map d(x, y), and outputs an output disparity map D(x, y) in the non-planar region.

First, an input disparity histogram h(d) is created with respect to the disparity map d(x, y) which is obtained in the disparity calculation unit 20. The input disparity histogram uses pixels in both regions of a planar region and a non-planar region. The disparity map d(x, y) takes only a disparity value of integer. In a case where there is disparity of decimal, the disparity is converted into an integer value by multiplying constant corresponding to accuracy of the disparity. For example, in a case where the disparity has pixel accuracy of ¼, it is possible to make the value d(x, y) be integer by multiplying constant 4 to the disparity value. Alternatively, the disparity may be rounded so as to be an integer value using rounding off, or the like.

When creating the input disparity histogram, the number of pixels with the disparity value d in the disparity map d(x, y) is counted, and the number of pixels is determined to be a frequency of the histogram h(d). In addition, a maximum value and a minimum value of the disparity map d(x, y) are obtained, and are set to dmax, and dmin, respectively. According to the embodiment, the disparity histogram is created using a disparity value in a level value of the disparity histogram as is; however, a disparity histogram in which a plurality of disparity values are put together to be one bin may be created.

Subsequently, a histogram equalization process is performed with respect to the created input disparity histogram h(d). First, a cumulative histogram P(d) is obtained using the following expression (3). Here, N is the number of pixels of a disparity map.

$$\begin{matrix}[ Expression 1 ] & \\ P ( d ) = \frac{1}{N} {\sum }_{δ = d min}^{d} h ( δ ) & ( 3 )\end{matrix}$$

Subsequently, a non-linear conversion property in which a disparity value D after conversion is set to f(d) is created using the following expression (4).

f(d)=(Dmax−Dmin)·P(d)+Dmin (4)

Here, Dmax and Dmin are constants which satisfy Dmax≧Dmin which is provided in advance, and denote a maximum value and a minimum value of a disparity map after conversion, respectively. In a case where dmax−dmin is smaller than Dmax−Dmin, a disparity range after conversion is increased, and in a case where dmax−dmin is larger than Dmax−Dmin, the disparity range after conversion is reduced. Other than that, it is also possible to perform constant multiplication of dmax and dmin, respectively, using constants which are predetermined. In addition, in a case where dmax=dmin, it is set to f(d)=Dmax.

In the expression (4), a histogram equalization is performed, and a disparity histogram after conversion h′(d) which is obtained by performing the conversion in the expression (4) with respect to d of the input disparity histogram h(d) becomes a histogram with an approximately constant frequency.

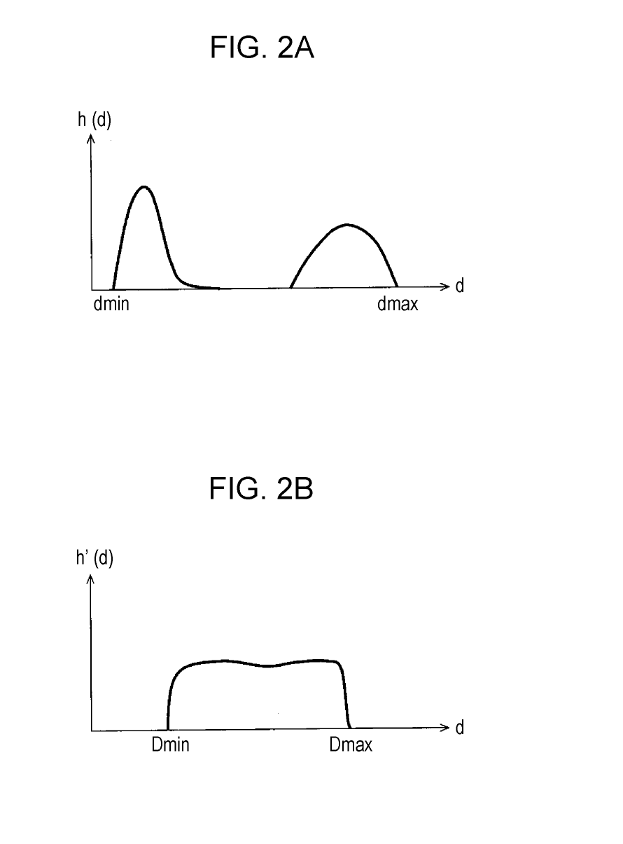

An example of a conversion process in the non-planar region disparity conversion processing unit 32 will be described with reference to FIGS. 2A and 2B. FIG. 2A illustrates an example of the input disparity histogram h(d), and FIG. 2B illustrates an example of the disparity histogram h′(d) after conversion which is a histogram obtained by performing a conversion process with respect to h(d) in FIG. 2A.

In FIGS. 2A and 2B, examples related to disparity of an image in which the entire screen are configured of only two objects are illustrated. As illustrated in FIG. 2A, there are two peaks in the input disparity histogram, and the respective peaks denote disparity distribution in one object. A wide interval between two peaks means that there is a large difference in disparity between objects, and denotes that there is discontinuous depth change between objects. For this reason, when the stereoscopic image is displayed and observed, there is a possibility that perception of a continuous depth change in an object is suppressed, and an unnatural three-dimensional sensation occurs.

In contrast to this, like the disparity histogram h′(d) after conversion which is illustrated in FIG. 2B, the histogram becomes a planar shape after conversion. In FIG. 2B, since the histogram is not divided into two peaks due to conversion, it is understood that there is a small difference in disparity between objects, and a discontinuous depth change between objects is suppressed. In addition, in the example, dmax−dmin is larger than Dmax−Dmin, and a disparity range after conversion is reduced. In addition, a degree of flatness of the disparity histogram after conversion is different according to a degree of intervals of bin of the input disparity histogram, or a degree of deviation in distribution.

The non-planar region disparity conversion processing unit 32 finally converts a disparity value of a non-planar region (L=0) using the conversion property in the expression (4) as in the following expression (5). Here, L is a label value (label number) attached to a pixel (x, y).

D(x, y)=f(d(x, y)), (L=0) (5)

In the planar region disparity conversion processing unit 33, a second conversion process in which disparity is converted using a conversion property which is different from that in the first conversion process (conversion process with respect to non-planar region) is performed with respect to a planar region. In addition, order of the first conversion process and the second conversion process does not matter.

In the example, the planar region disparity conversion processing unit 33 converts the input disparity map d(x, y), and outputs the output disparity map D(x, y) in the planar region. Here, in the planar region disparity conversion processing unit 33, disparity is converted linearly using the following expression (6) among each of planar regions (L>0) which is subjected to labeling.

$$\begin{matrix}[ Expression 2 ] & \\ D ( x , y ) = \frac{f ( {d}_{max}^{( L )} ) - f ( {d}_{min}^{( L )} )}{{d}_{max}^{( L )} - {d}_{min}^{( L )}} ( d ( x , y ) - {d}_{min}^{( L )} ) + f ( {d}_{min}^{( L )} ) , ( L > 0 ) & ( 6 )\end{matrix}$$

L is a label value (label number) which is attached to the pixel (x, y). d^{(L)}ₘₐₓ and d^{(L)}ₘᵢₙ are respectively a maximum value and a minimum value of d(x, y) in a region in which a label number is L. In a region of each label number, since a linear conversion is performed with respect to disparity distribution of the input disparity map, even in a case where the region is an inclined plane, it is possible to make gradient of disparity (rate of change in horizontal or vertical direction) constant in the region, and to keep the gradient planar, without an occurrence of unnatural distortion after conversion.

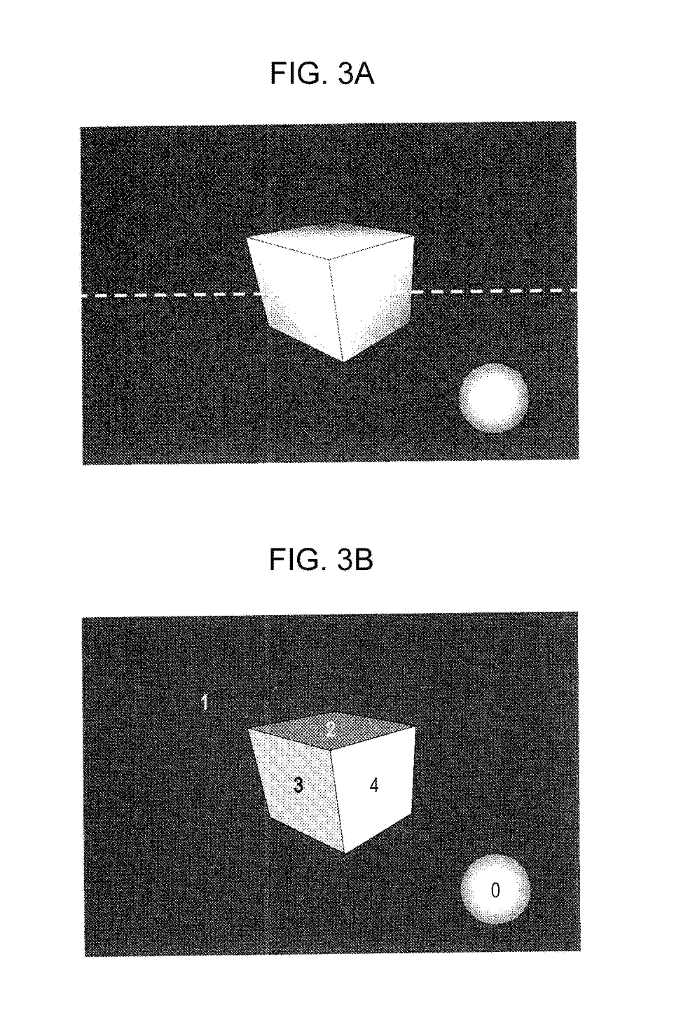

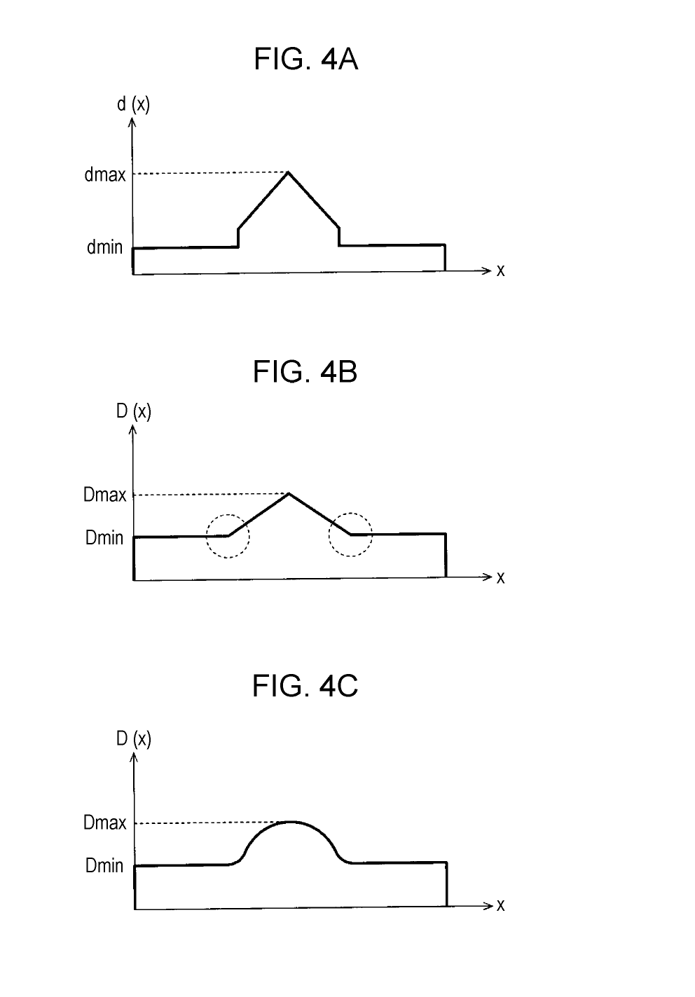

Subsequently, an example of a disparity distribution conversion process according to the embodiment will be described using a specific example of a disparity map with reference to FIGS. 3A, 3B, 4A, 4B, and 4C. An example of a disparity map which is calculated in the disparity calculation unit 20 is illustrated in FIG. 3A. In addition, a disparity value of a certain row in the disparity map in FIG. 3A (portion of dotted line in FIG. 3A) which is made into a graph is illustrated in FIG. 4A.

More specifically, FIGS. 3A and 4A will be described. FIG. 3A is an example of a disparity map which is input to the disparity distribution conversion unit 30, and is a disparity map in an image in which a cube and a ball are floated on a background with a constant disparity value. In the disparity map, a disparity value which is calculated in each pixel is assigned to a luminance value, and in which spatial distribution of a disparity map in a stereoscopic image is expressed by assigning a luminance value which becomes large toward a popup direction to a luminance value which becomes small toward a depth direction. In addition, in FIG. 3A, a black solid line is drawn in each side of the cube; however, it is for illustrating the cube so as to be easily understood as a cube, and a luminance value is not set to be small in each side of the cube in practice.

An example of a result which is obtained by performing a labeling process of the planar region extraction unit 31 with respect to the disparity map in FIG. 3A is illustrated in FIG. 3B. In FIG. 3B, a region is divided into five regions which are attached with label values of 0 to 4, and the regions are denoted using shading which is different in each region. A label value 0 which denotes that it is not a plane is attached to a portion of the ball. The background portion is extracted as one plane, and a label value 1 is attached thereto. Three faces of the cube which are viewed are extracted as different planes, respectively, and are attached with label values of 2 to 4.

FIG. 4A is a graph in which, in a disparity value on a row of a dotted line of a disparity map in FIG. 3A, a vertical axis is set to a disparity value (by setting disparity value in popup direction to be large, and disparity value in depth direction to be small), and a horizontal axis is assigned to coordinates in a horizontal direction. In FIG. 4A, it is understood that a disparity value at a background portion is constant, and a disparity value at a cubic portion is larger than that.

An example of a result which is obtained by performing a process of the disparity distribution conversion unit 30 with respect to the disparity value in FIG. 4A is illustrated in FIG. 4B. In FIG. 4B, regions which are surrounded with dotted circles are rapidly changed in disparity in FIG. 4A; however, the change becomes mild in FIG. 4B. In addition, also in a convex portion at a center which is a cubic region, the disparity is linearly changed, and it becomes an inclined plane with a constant inclination.

FIG. 4C is an example of a conversion result with respect to the disparity value in FIG. 4A in a case where the output disparity map D(x, y) is calculated using D(x, y)=f(d(x, y)) in the entire pixel without dividing into a planar region and a non-planar region similarly to a method in the related art, as a comparison. In FIG. 4C, a convex portion at a center is curvilinearly changed, and a cubic portion becomes a curved surface-shaped disparity.

In addition, in a case where a stereoscopic image is configured of two viewpoint images, the disparity distribution conversion unit 30 performs a conversion of disparity distribution derived from the two viewpoint images. In a case where the stereoscopic image is configured of three or more viewpoint images, such detection and conversion processes may be performed between a certain determined viewpoint image (reference viewpoint image) and other plurality of viewpoint images, respectively.

Returning to FIG. 1, a process after the disparity distribution conversion will be described. The image generation unit 40 reconstitutes a separate viewpoint image from the reference viewpoint image, and a disparity map after conversion in the disparity distribution conversion unit 30. The reconstituted separate viewpoint image is referred to as a separate viewpoint image for display. More specifically, the image generation unit 40 reads a disparity value of coordinates thereof from the disparity map with respect to each pixel of a reference designation image, and copies a pixel value in an image of which coordinates are shifted by the disparity value in the separate viewpoint image to be reconstituted. This process is performed with respect to all of pixels of the reference viewpoint image; however, in a case where a plurality of pixel values are allocated to the same pixel, a pixel value of a pixel with a maximum disparity value in a popup direction is used based on a Z-buffer method.

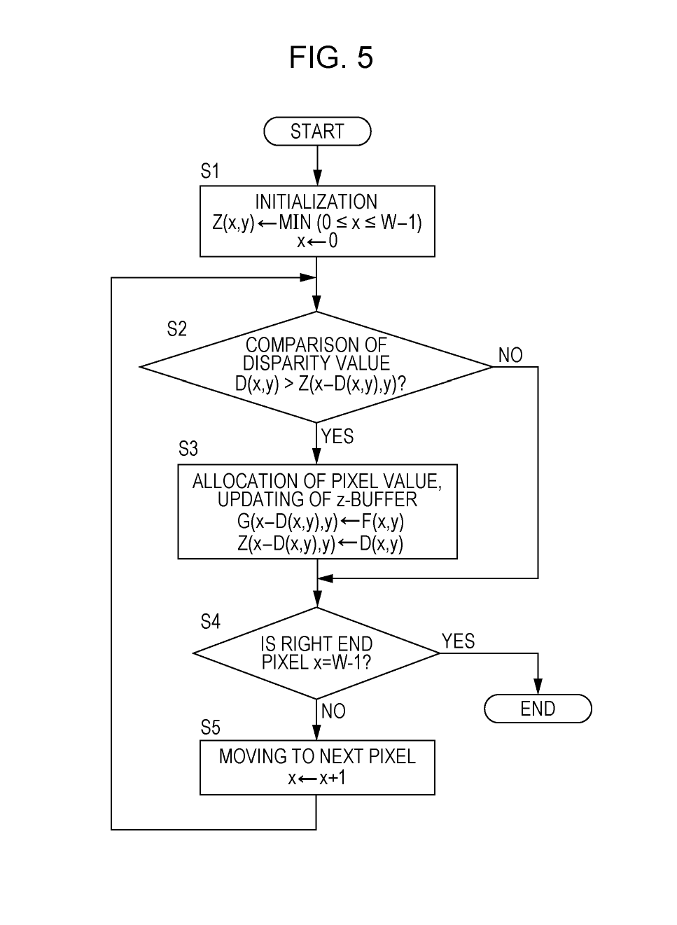

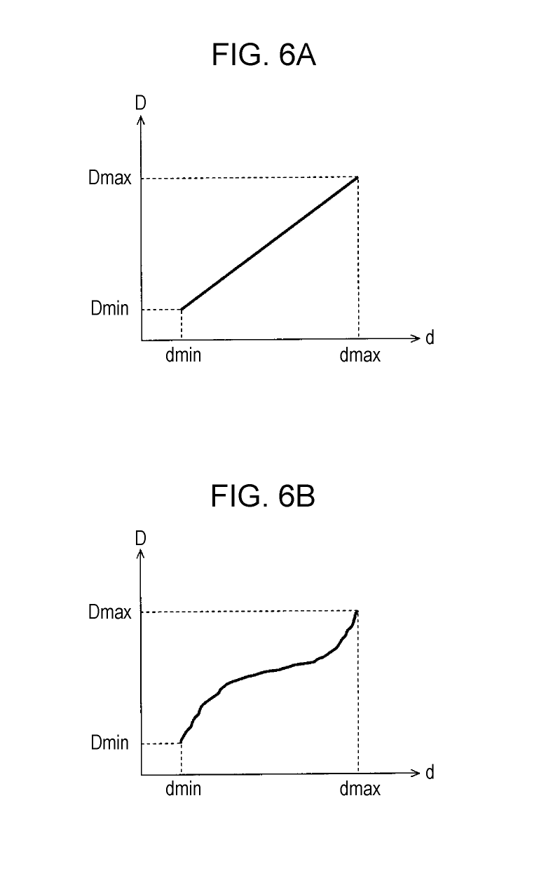

An example of a reconstitution process of a separate viewpoint image in the image generation unit 40 will be described with reference to FIG. 5. FIG. 5 is an example in a case where a left eye image is selected as a reference viewpoint image. (x, y) denotes coordinates in an image; however, it is a process in each row in FIG. 5, and y is constant. F, G, and D respectively denote the reference viewpoint image, the separate viewpoint image for display, and the disparity map. Z is an array for holding a disparity value of each pixel in the separate viewpoint image for display in the process, and is referred to as a z buffer. W is the number of pixels of an image in the horizontal direction.

First, in step S1, the z buffer is initialized using an initializing value MIN. The disparity value is set so as to be a positive value in a case of a popup direction, and be a negative value in a case of a depth direction, and MIN is set to a value smaller than a minimum value of disparity which is converted in the disparity distribution conversion unit 30. In addition, in order to perform a process from a left end pixel in order in steps hereinafter, 0 is input to x. In step S2, a disparity value of a disparity map is compared to a z-buffer value of a pixel of which coordinates are moved by the disparity value, and whether or not the disparity value is larger than the z-buffer value is determined. In a case where the disparity value is larger than the z-buffer value, the process proceeds to step S3, and a pixel value of the reference viewpoint image is allocated to the separate viewpoint image for display. In addition, the z-buffer value is updated.

Subsequently, in step S4, in a case where the current coordinates are a right end pixel, the process ends, and if not, the process proceeds to step S5, the current coordinates move to a pixel which is a right-hand neighbor, and the process returns to step S2. In step S2, in a case where the disparity value is the z-buffer value or less, the process proceeds to step S4 by omitting step S3. These procedures are performed with respect to all rows.

In addition, in the stereoscopic image display apparatus according to the embodiment, the image generation unit 40 performs an interpolation process with respect to a pixel to which a pixel value is not allocated, and allocates a pixel value. That is, the image generation unit 40 includes an image interpolation unit, and is able to determine a pixel value at any time. The interpolation process is performed with respect to a pixel to which a pixel value is not allocated using a mean value of pixel values of a pixel which is closest to the pixel on the left side thereof, and to which a pixel value is allocated, and a pixel which is closest to the pixel on the right side thereof, and to which a pixel value is allocated. Here, the mean value of the value of the vicinity pixel is used as the interpolation process; however, it is not limited to the method of using the mean value, weighting corresponding to a distance of a pixel may be performed, and another method of adopting a filtering process other than that, or the like, may be adopted.

The display unit 50 is configured of a display device, and a display control unit which performs a control of outputting a stereoscopic image which has display elements of the reference viewpoint image, and the separate viewpoint image for display which is generated in the image generation unit 40 with respect to the display device. That is, the display unit 50 inputs the reference viewpoint image, and the generated separate viewpoint image for display, and performs a two-eye or multi-eye stereoscopic display. In a case where the reference viewpoint image in the input unit 10 is a left eye image, and the separate viewpoint image is a right eye image, the reference viewpoint image is displayed as the left eye image, and the separate viewpoint image for display is displayed as the right eye image. In a case where the reference viewpoint image is the right eye image, and the separate viewpoint image is the left eye image in the input unit 10, the reference viewpoint image is displayed as the right eye image, and the separate viewpoint image for display is displayed as the left eye image.

In addition, in a case where the image which is input in the input unit 10 is a multi-viewpoint image, the reference viewpoint image and the separate viewpoint image for display are displayed by being aligned so as to be the same order as that at a time of inputting. In addition, in a case where image data which is input to the input unit 10 is image data and depth data, or disparity data, the image data is determined according to configuration of whether the image data is to be used in a left eye image, or in a right eye image.

As described above, according to the embodiment, in the planar region, there is no occurrence of an unnatural distortion in which a plane is viewed as a curved surface since disparity is adjusted linearly. In addition, according to the embodiment, in a region other than that (non-planar region), since the equivalent process as that in which a discontinuous disparity change at a boundary of objects is suppressed is performed by adjusting disparity so that a frequency of disparity becomes uniform using histogram equalization, it is possible to avoid an unnatural three-dimensional sensation in which a continuous depth change is deficient such as a cardboard effect due to a suppression of perception of a continuous depth change (continuous depth change in object). As described above, according to the embodiment, it is possible to adaptively change a disparity distribution of a stereoscopic image according to a visual property of a human related to stereopsis by performing different disparity adjusting between a planar region and a non-planar region, and as a result, it is possible to display an image with a natural three-dimensional sensation.

According to the embodiment, in the non-planar region disparity conversion processing unit 32, a non-linear disparity conversion property has been created using disparity histogram; however, there is no limitation to this, and for example, the non-linear disparity conversion property may be created using another method such as a conversion property of a sigmoid function-type. That is, an example in which the first conversion process in the non-planar region disparity conversion processing unit 32 is a process of performing a conversion based on a histogram equalization process of disparity with respect to a non-planar region has been described; however, it is not limited to the example, and it is possible to avoid an occurrence of the unnatural three-dimensional sensation due to a suppression of perception of a continuous depth change (continuous depth change in object), similarly, when a conversion based on the non-linear conversion property related to disparity is performed with respect to the non-planar region.

According to the embodiment, in the planar region extraction unit 31, a planar region has been extracted based on a gradient of disparity using a horizontal gradient map and a vertical gradient map of a disparity map; however, there is no limitation to this, and the planar region may be extracted using another method such as a method of extracting a region in which a luminance value is constant, a method of extracting a region in which texture is uniform, or the like, for example.

In addition, according to the embodiment, the example in which the second conversion process in the planar region disparity conversion processing unit 33 is a process in which a conversion based on a linear conversion property related to disparity is performed with respect to a planar region has been described. However, it is not limited to the example, and in the present invention, another conversion process (second conversion process) may be performed, in which the non-planar region disparity conversion processing unit 32 performs a conversion process in which disparity is converted (first conversion process) with respect to a non-planar region, and the planar region disparity conversion processing unit 33 converts disparity using a conversion property which is different from the conversion process in the non-planar region with respect to a planar region.

For example, a non-linear conversion process may be performed with respect to a non-planar region, and a conversion process in which a degree of non-linearity is smaller (that is, close to linearity) than the conversion process may be performed with respect to a planar region. Also in such a configuration, even in a case where the planar region is an inclined plane, it is possible to make gradient of disparity (rate of change in horizontal direction or vertical direction) constant in a region, planarity is held without an occurrence of unnatural distortion even after a conversion, and as a result, it is possible to adaptively change disparity distribution of a stereoscopic image according to a visual property of a human related to stereopsis.

In addition, in the stereoscopic image display apparatus according to the embodiment, adjusting of a degree (for example, above described each constant) of a change (adjustment) in disparity distribution of a stereoscopic image corresponds to an adjustment of a disparity amount in the stereoscopic image. Such a degree of change may be operated by a viewer from the operation unit, or may be determined according to a default setting. In addition, the degree of change may be changed according to disparity distribution. In addition to this, the degree of change may be changed according to an index other than disparity of a stereoscopic image such as genre of a stereoscopic image, or an image feature amount such as average luminance of a viewpoint image which configures the stereoscopic image. In any of the adjustments, in the embodiment which is described in FIG. 1, or the like, since a difference in disparity value in a boundary of objects (region in which disparity value is discontinuously changed) is reduced, and a planar region is converted so as to hold planarity, it is possible to present a good three-dimensional sensation. In addition, in the present invention including the embodiment, in any of the adjustments, since it is possible to adaptively convert disparity distribution of a stereoscopic image according to a visual property of a human related to stereopsis (according to visual property of human related to stereopsis which is described in NPL 1), it is possible to present a good three-dimensional sensation.

Hitherto, the example of converting disparity distribution has been described; however, it is possible to convert depth distribution by performing the first and second conversion processes with respect to depth instead of disparity. That is, the stereoscopic image processing apparatus according to the present invention can be configured so as to perform adjusting of a depth value, instead of performing an adjustment of a disparity value, and exhibits the same effect according to such a configuration.

In order to do this, in the stereoscopic image processing apparatus, a depth distribution conversion unit may be provided instead of the disparity distribution conversion unit 30. In the depth distribution conversion unit, the non-planar region depth conversion processing unit may be provided instead of the non-planar region disparity conversion processing unit 32 along with the planar region extraction unit 31, and a planar region depth conversion processing unit may be provided instead of the planar region disparity conversion processing unit 33. In such a case, for example, a disparity value which is output from the disparity calculation unit 20 may be input to the depth distribution conversion unit by converting the disparity value into a depth value (or inputs depth data to depth distribution conversion unit from input unit 10), adjusting of the depth value may be performed in the depth distribution conversion unit, and the adjusted depth value may be input to the image generation unit 40 by being converted into a disparity value.

In addition, the stereoscopic image display apparatus according to the present invention has been described; however, the present invention also can adopt an embodiment as a stereoscopic image processing apparatus in which a display device is omitted from the stereoscopic image display apparatus. That is, the display device itself which displays a stereoscopic image may be mounted on a main body of the stereoscopic image processing apparatus according to the present invention, and may be connected to the outside. Such a stereoscopic image processing apparatus can also be incorporated with another image output device such as various recorders, or various recording media reproducing devices, in addition to incorporation with a television or a monitor.

In addition, a portion corresponding to the stereoscopic image processing apparatus according to the present invention (that is, constituent element except for display device which is provided in display unit 50) in each unit in the stereoscopic image display apparatus which is exemplified in FIG. 1 can be realized using, for example, hardware such as a microprocessor (or, Digital Signal Processor (DSP)), a memory, a bus, an interface, and a peripheral device, and software which can be executed in the hardware. It is possible to mount a part or all of the hardware as an integrated circuit/IC chip set such as large scale integration (LSI), and in this case, the software may be stored in the memory. In addition, all of each of the configuration elements in the present invention may be configured using hardware, and also in that case, similarly, it is possible to mount a part or all of the hardware as the integrated circuit/IC chip set.

In addition, in the above described embodiment, each of constituent elements for executing a function is described as a portion which is different, respectively; however, it is not essential to include portions which can be recognized by being clearly separated in this manner in practice. The stereoscopic image processing apparatus which executes functions of the present invention may configure each constituent element for executing functions using respectively different portions in practice, or may install all of constituent elements as one integrated circuit/IC chip set, for example, may be any of installing forms, and may include each constituent elements as functions.

In addition, it is also possible to simply configure the stereoscopic image processing apparatus according to the present invention using a Central Processing Unit (CPU), a storage unit, or the like, such as a Random Access Memory (RAM) as a work area, a Read Only Memory (ROM), or an Electrically Erasable Programmable ROM (EEPROM) as a storage region of a program for controlling. In such a case, the above described program for controlling includes a stereoscopic image processing program for executing the process according to the present invention, which will be described later. The stereoscopic image processing program can also be integrated as application software for displaying a stereoscopic image in a personal computer, and can cause the personal computer to function as the stereoscopic image processing apparatus. In addition, the stereoscopic image processing program may be stored in an external server such as a Web server in a state of being executed from a client personal computer.

Hitherto, the stereoscopic image processing apparatus according to the present invention has been mainly described; however, the present invention also adopts an embodiment as a stereoscopic image processing method as exemplified in a flow of a control in the stereoscopic image display apparatus including the stereoscopic image processing apparatus. The stereoscopic image processing method is a method in which a stereoscopic image is input, and distribution of disparities or depths of the input stereoscopic image is converted, the method including a step of extracting a planar region in a stereoscopic image using the planar region extracting unit; a step of performing a first conversion process in which the disparity or the depth is converted with respect to a non-planar region which is a region other than a planar region using the non-planar region conversion processing unit; and a step of performing a second conversion process in which the disparity or the depth is converted using a conversion property which is different from that in the first conversion process with respect to the planar region using the planar region conversion processing unit. Here, the first conversion process is a process in which a conversion based on a non-linear conversion property is performed related to the disparity or the depth with respect to the non-planar region. An application example other than that is the same as that which is described in the stereoscopic image display apparatus.

In addition, the present invention also adopts an embodiment as a stereoscopic image processing program for causing a computer to execute the stereoscopic image processing method. That is, the stereoscopic image processing program is a program for causing a computer to input a stereoscopic image, and to execute stereoscopic image processing in which distribution of disparities or depths of the input stereoscopic image is converted. The stereoscopic image processing includes a step of extracting a planar region in the stereoscopic image; a step of performing a first conversion process in which the disparity or the depth is converted with respect to a non-planar region which is a region other than the planar region; and a step of performing a second conversion process in which the disparity or the depth is converted using a conversion property which is different from that in the first conversion process with respect to the planar region. Here, the above described first conversion process is a process in which a conversion based on a non-linear conversion property is performed related to the disparity or the depth with respect to the non-planar region. An application example other than that is the same as that which is described in the stereoscopic image display apparatus.

In addition, it is also possible to easily understand an embodiment as a program recording medium in which the stereoscopic image processing program is recorded in a computer-readable recording medium. The computer is not limited to a general-purpose personal computer, as described above, and it is possible to apply various types of computer such as a microcomputer, or a programmable general-purpose integrated circuit/chip set. In addition, the program is not limited to distribution through a portable recording medium, and it is also possible to distribute the program through a network such as the Internet, or through a broadcast wave. Receiving a program through a network means that a program which is recorded in a storage unit of an external server, or the like, is received.

As described above, the stereoscopic image processing apparatus according to the present invention is a stereoscopic image processing apparatus which inputs a stereoscopic image, and converts distribution of disparities or depths of an input stereoscopic image, the apparatus includes a planar region extracting unit which extracts a planar region in the stereoscopic image; a non-planar region conversion processing unit which performs a first conversion process in which the disparity or the depth is converted with respect to a non-planar region which is a region other than the planar region; and a planar region conversion processing unit which performs a second conversion process in which the disparity or the depth is converted using a conversion property which is different from that in the first conversion process with respect to the planar region, in which the first conversion process is a process in which a conversion based on a non-linear conversion property is performed related to the disparity or the depth with respect to the non-planar region. In this manner, it is possible to avoid an occurrence of an unnatural three-dimensional sensation due to a suppression of perception of a continuous depth change (continuous depth change in object). Accordingly, it is possible to adaptively convert distribution of disparities or depths of a stereoscopic image according to a visual property of a human related to stereopsis.

In addition, the first conversion process can also be characterized as a process in which a conversion based on a histogram equalization process of disparities or depths is performed with respect to the non-planar region. It is possible to avoid an occurrence of an unnatural three-dimensional sensation due to a suppression of perception of a continuous depth change (continuous depth change in object) similarly, according to such a conversion.

In addition, it is preferable that the second conversion process is characterized as a process in which a conversion based on a linear conversion property is performed related to the disparity or the depth with respect to the planar region. In this manner, it is possible to make gradient of the disparity (rate of change in horizontal direction or vertical direction) constant in a region, even in the case where the planar region is an inclined plane, and to hold planarity thereof without an occurrence of unnatural distortion even after the conversion.

The stereoscopic image processing method according to the present invention is a stereoscopic image processing method in which a stereoscopic image is input, and distribution of disparities or depths of the input stereoscopic image is converted, the method including a step of extracting a planar region in the stereoscopic image using the planar region extracting unit; a step of performing a first conversion process in which the disparity or the depth is converted with respect to a non-planar region which is a region other than the planar region using the non-planar region conversion processing unit; and a step of performing a second conversion process in which the disparity or the depth is converted using a conversion property which is different from that in the first conversion process with respect to the planar region using the planar region conversion processing unit, in which the first conversion process is a process in which a conversion based on a non-linear conversion property is performed related to the disparity or the depth with respect to the non-planar region. In this manner, it is possible to adaptively convert distribution of disparities or depths of a stereoscopic image according to a visual property of a human related to stereopsis.

The program according to the present invention is a program for causing a computer to input a stereoscopic image, and to execute stereoscopic image processing in which distribution of disparities or depths of the input stereoscopic image is converted, in which the stereoscopic image processing includes a step of extracting a planar region in the stereoscopic image; a step of performing a first conversion process in which the disparity or the depth is converted with respect to a non-planar region which is a region other than the planar region; and a step of performing a second conversion process in which the disparity or the depth is converted using a conversion property which is different from that in the first conversion process with respect to the planar region, and in which the first conversion process is a process in which a conversion based on a non-linear conversion property is performed related to the disparity or the depth with respect to the non-planar region. In this manner, it is possible to adaptively convert distribution of disparities or depths of a stereoscopic image according to a visual property of a human related to stereopsis.

### REFERENCE SIGNS LIST

10 INPUT UNIT

20 DISPARITY CALCULATION UNIT

30 DISPARITY DISTRIBUTION CONVERSION UNIT

31 PLANAR REGION EXTRACTION UNIT

32 NON-PLANAR REGION DISPARITY CONVERSION PROCESSING UNIT

33 PLANAR REGION DISPARITY CONVERSION PROCESSING UNIT

40 IMAGE GENERATION UNIT

50 DISPLAY UNIT

1-5. (canceled)

6. A stereoscopic image processing apparatus which receives an input stereoscopic image, and converts distribution of disparities or depths of the input stereoscopic image, the apparatus comprising:
a planar region extracting unit which extracts a planar region in the stereoscopic image;
a non-planar region conversion processing unit which performs a first conversion process in which the disparity or the depth is converted with respect to a non-planar region which is a region other than the planar region; and
a planar region conversion processing unit which performs a second conversion process in which the disparity or the depth is converted using a conversion property which is different from that in the first conversion process with respect to the planar region,
wherein the first conversion process is a process in which a conversion based on a non-linear conversion property is performed related to the disparity or the depth with respect to the non-planar region.

7. The stereoscopic image processing apparatus according to claim 6,
wherein the first conversion process is a process in which a conversion based on a histogram equalization process of the disparity or the depth is performed with respect to the non-planar region.

8. The stereoscopic image processing apparatus according to claim 6,
wherein the second conversion process is a process in which a conversion based on a linear conversion property is performed related to the disparity or the depth with respect to the planar region.

9. The stereoscopic image processing apparatus according to claim 7,
wherein the second conversion process is a process in which a conversion based on a linear conversion property related to disparity or a depth is performed with respect to the planar region.

10. A stereoscopic image processing method in which a stereoscopic image is input, and distribution of disparities or depths of the input stereoscopic image is converted, the method comprising:
a step of extracting, by a planar region extracting unit, a planar region in the stereoscopic image;
a step of performing, by a non-planar region conversion processing unit, a first conversion process in which the disparity or the depth is converted with respect to a non-planar region which is a region other than the planar region; and
a step of performing, by a planar region conversion processing unit, a second conversion process in which the disparity or the depth is converted using a conversion property which is different from that in the first conversion process with respect to the planar region,
wherein the first conversion process is a process in which a conversion based on a non-linear conversion property is performed related to the disparity or the depth with respect to the non-planar region.

11. A non-transitory computer-readable recording medium in which a program which causes a computer to execute stereoscopic image processing in which a stereoscopic image is input, and distribution of disparities or depths of the input stereoscopic image is converted is recorded, the stereoscopic image processing including:
a step of extracting a planar region in the stereoscopic image;
a step of performing a first conversion process in which the disparity or the depth is converted with respect to a non-planar region which is a region other than the planar region; and
a step of performing a second conversion process in which the disparity or the depth is converted using a conversion property which is different from that in the first conversion process with respect to the planar region,
wherein the first conversion process is a process in which a conversion based on a non-linear conversion property is performed related to the disparity or the depth with respect to the non-planar region.
